(19) United States
(12) Patent Application Publication
(10) Pub. No.: US 2020/0057441 A1
(43) Pub. Date: Feb. 20, 2020

(54) SYSTEMS AND METHODS FOR INTELLIGENT ARBITRATION BETWEEN AUTONOMOUS AND MANUAL OPERATION SIGNALS OF AN AUTONOMOUS AGENT

(71) Applicant: May Mobility, Inc., Ann Arbor, MI (US)

(72) Inventors: John Wang, Ann Arbor, MI (US); Justin Tesmer, Ann Arbor, MI (US); Edwin B. Olson, Ann Arbor, MI (US); Steven Vozar, Ann Arbor, MI (US)

(21) Appl. No.: 16/540,836

(22) Filed: Aug. 14, 2019

Related U.S. Application Data
(60) Provisional application No. 62/718,642, filed on Aug. 14, 2018.

(51) Int. Cl. G05D 1/00

(52) U.S. Cl. CPC G05D 1/0061; G05D 1/0088

(57) ABSTRACT

Systems and methods for intelligently implementing an autonomous agent include: implementing a computer-based control circuit that generates computer-based control signals for controlling a driving operation of an autonomous agent; enabling a non-computer control source that provides non-computer-based control signals for controlling the operation of the autonomous agent; implementing a dedicated arbiter circuit that selectively passes control signals from either the computer-based control circuit or the non-computer control source to lower-level driving mechanisms; and implementing a takeover circuit that source s a takeover signal to the dedicated arbiter circuit based on detecting non-computer-based control signals having non-nominal control values from the non-computer control source, wherein in response to the takeover signal, the dedicated arbiter circuit dynamically switches from passing the computer-based control signals from the computer-based control circuit to passing non-computer-based control signals from the non-computer control source for controlling the lower-level driving mechanisms of the autonomous agent.

### CROSS-REFERENCE TO RELATED APPLICATIONS

This application claims the benefit of U.S. Provisional Application No. 62/718,642, filed 14 Aug. 2018, which is incorporated in its entirety by this reference.

### TECHNICAL FIELD

The inventions relate generally to the vehicle automation field, and more specifically to new and useful systems and methods for intelligently arbitrating modes of operating an autonomous agent in the vehicle automation field.

### BACKGROUND

State of the art vehicle automation presently enables some autonomous vehicles to operate in a substantially and/or fully autonomous state. An ability of such autonomous vehicles to operate effectively and safely in busy or active environments often relies on an ability of the autonomous agent to observe its operating environment and make operating decisions that enables the autonomous agent to achieve a routing or traveling goal in a safe manner.

Additionally, a safe operation of any autonomous agent can also include manners in which a human operator is able to switch from a fully autonomous state to a lesser state including a semi-autonomous state or a manual state (i.e., the autonomous agent may be under full human control). In modern autonomous agents, such as autonomous vehicles, a human operator may typically select an autonomous mode of operation of the autonomous vehicle and correspondingly, to cease autonomous operations of the autonomous vehicle. In such cases, the human operator must typically de-select from an autonomous state or mode of the autonomous vehicle using a specific toggling input method or source (e.g., a selectable button, manual lever, etc.).

However, in some situations (including urgent or emergency circumstances, ferrying in and out of a garage, etc.), a human operator's initial response may not be to perform the specific toggling function that enables a switching from autonomous mode but instead, perform manual operations using driving mechanisms and/or driving interface components to attempt to take immediate control of the autonomous agent. As a result of a manual driving intervention by a human operator while the autonomous agent is in a fully autonomous state or mode, collisions between the autonomous commands by an onboard computer or the like and the manual commands of the human are possible that my adversely affect an overall safe operation of the autonomous vehicle.

To achieve safe autonomous operation, autonomous vehicles may be configured with many sensors, source s of compute, source s of power and actuators that operate together to enable the autonomous vehicle to perceive and comprehend its environment and further, compute decisions and controls that optimizes how safely that the autonomous vehicle traverses the environment.

Thus, there is a need in the vehicle automation field for systems and method for safely and intelligently arbitrating between autonomous commands and manual commands simultaneously placed to an autonomous vehicle. The embodiments of the present application described herein provide technical solutions that address, at least, the need described above.

### BRIEF DESCRIPTION OF THE FIGURE S

FIG. 1 illustrates a schematic representation of a system for implementing an autonomous agent in accordance with one or more embodiments of the present application;

FIG. 1A illustrates an example schematic representation of an autonomous agent operating system in accordance with one or more embodiments of the present application;

FIG. 2 illustrates an example method in accordance with one or more embodiments of the present application;

FIG. 3 illustrates an example schematic of a subsystem 300 of the system 100 for identifying a level of autonomous operation of an autonomous agent in accordance with one or more embodiments of the present application;

FIG. 4 illustrates an example schematic of a subsystem 400 of the system 100 for selectively transmitting autonomous control instructions for safely controlling an autonomous agent in accordance with one or more embodiments of the present application;

FIG. 5 illustrates an example schematic of a subsystem 500 of the system 100 for arbitrating driving commands in accordance with one or more embodiments of the present application; and

FIG. 6 illustrates an example schematic of a subsystem 500 of the system 100 for actively arbitrating driving commands based on a takeover signal in accordance with one or more embodiments of the present application.

### BRIEF SUMMARY OF THE INVENTION(S)

In one embodiment, a system for intelligently implementing an autonomous agent includes a computer-based control source that generates autonomous computer-based control signals for controlling a driving operation of an autonomous agent; a non-computer control source that provides non-computer-based control signals for controlling the operation of the autonomous agent; a dedicated arbiter of control signals that selectively passes one or more control signals from either the computer-based control source or the non-computer control source to one or more lower-level driving mechanisms of the autonomous agent; and a takeover module that source s a takeover signal to the dedicated arbiter based on detecting one or more non-computer-based control signals having non-nominal control values from the non-computer control source, wherein in response to the takeover signal, the dedicated arbiter dynamically switches from passing the autonomous computer-based control signals from the computer-based control source to passing non-computer-based control signals from the non-computer control source for controlling the one or more lower-level driving mechanisms of the autonomous agent.

In one embodiment, the computer-based control source generates autonomous computer-based control signals enable a self-driving of the autonomous agent; and the non-computer control source provides non-computer-based control signals that enable a full manual or a semi-manual driving of the autonomous agent by a human user.

In one embodiment, the one or more lower-level driving mechanisms of the autonomous agent include one or more components that, when actuated by a control signal, physical perform a driving action of the autonomous agent.

In one embodiment, the takeover signal relates to a signal or a command instruction indicating that a non-computer control source is attempting to obtain or has obtained manual control of the autonomous agent.

In one embodiment, in a first, autonomous operating mode of the autonomous agent: the computer-based control source fully controls the driving operations of the autonomous agent without human intervention, the dedicated arbiter selectively passes only the computer-based control signals from the computer-based control source, and the non-computer-based control signals from the non-computer control source include control values for each of the lower-level driving mechanisms that are nominal control values.

In one embodiment, in a second, manual operating mode of the autonomous agent: the non-computer control source controls the driving operations of the autonomous agent, the dedicated arbiter selectively passes only the non-computer-based control signals from the non-computer control source, and the non-computer control signals from the non-computing control source include control values for each of the lower-level driving mechanisms of the autonomous agent that include non-nominal control values.

In one embodiment, in the second, manual operating mode, the computer control source continues to publish computer-based control signals having non-nominal control values.

In one embodiment, a nominal control value relates to a generated control value that does not satisfy or falls below a minimum control threshold for an executable control signal, and a non-nominal control value relates to a generated control value that satisfies or exceeds the minimum control threshold.

In one embodiment, the takeover module generates the takeover signal based on detecting an actuation of one or more user driving interface components of the autonomous agent.

In one embodiment, in response to the takeover signal, the dedicated arbiter blocks the computer-based control signals from the computer-based control source to the one or more lower-level driving mechanisms of the autonomous agent.

In one embodiment, the dedicated arbiter generates a feedback signal to the computer-based control source indicating that the computer-based control source does not have driving control of the autonomous agent.

In one embodiment, the dedicated arbiter implements a lockout of the computer control source thereby preventing the computer-based control signals published by the computer-based control source from being executed by the lower level driving mechanisms of the autonomous agent

In one embodiment, the system includes a monitoring module that identifies state data for each of a plurality of user driving interface components of the autonomous agent, wherein: the monitoring module computes state data for each of the plurality of user driving interface components based on a difference between a calibrated value of a respective one of the plurality of user driving interface components and a sensed value for the respective one of the plurality of user driving interface components, based on the computed state data, the takeover module generates the takeover signal when a control value associated with the computed state data for any of the plurality of driving mechanisms meets or exceeds a takeover threshold.

In one embodiment, the dedicated arbiter includes selection circuitry comprising a switch that operably switches between the computer-based control signals and the non-computer-based control signals based on an existence or a non-existence of the takeover signal.

In one embodiment, the driving operation relates to an action that changes a state of movement of the autonomous agent.

In one embodiment, a physical operation of a user driving interface component of the autonomous agent generates generate at least two distinct streams of control signals having non-nominal control values including the non-computer control signals and the takeover control signal.

In one embodiment, the takeover module is distinct from the non-computer control source.

In one embodiment, a method for intelligently implementing an autonomous agent includes: implementing a computer-based control circuit that generates autonomous computer-based control signals for controlling a driving operation of an autonomous agent; enabling a non-computer control source that provides non-computer-based control signals for controlling the operation of the autonomous agent; implementing a dedicated arbiter circuit that selectively passes one or more control signals from either the computer-based control circuit or the non-computer control source to one or more lower-level driving mechanisms of the autonomous agent; and implementing a takeover circuit that source s a takeover signal to the dedicated arbiter circuit based on detecting one or more non-computer-based control signals having non-nominal control values from the non-computer control source, wherein in response to the takeover signal, the dedicated arbiter circuit dynamically switches from passing the computer-based control signals from the computer-based control circuit to passing non-computer-based control signals from the non-computer control source for controlling the one or more lower-level driving mechanisms of the autonomous agent.

In one embodiment, in a first, autonomous operating mode of the autonomous agent: the computer-based control circuit fully controls the driving operations of the autonomous agent without human intervention, the dedicated arbiter selectively passes only the computer-based control signals from the computer-based control circuit, and the non-computer-based control signals from the non-computer control source include control values for each of the lower-level driving mechanisms that are nominal control values.

In one embodiment, in a second, manual operating mode of the autonomous agent: the non-computer control source controls the driving operations of the autonomous agent, the dedicated arbiter selectively passes only the non-computer-based control signals from the non-computer control source, and the non-computer control signals from the non-computing control source include control values for each of the lower-level driving mechanisms of the autonomous agent that include non-nominal control values.

### DESCRIPTION OF THE PREFERRED EMBODIMENTS

The following description of the preferred embodiments of the present application are not intended to limit the inventions to these preferred embodiments, but rather to enable any person skilled in the art to make and use these inventions.

### 1. Overview

As discussed in the background section, abrupt manual intervention by a human operator of an autonomous agent that is operating in an autonomous mode may cause collisions between the autonomous commands and manual commands from human interface devices.

As a technical solution, the one or more embodiments of the present application function to arbitrate between manual control commands and autonomous control commands to an autonomous agent that mitigates or eliminates possible collisions between the disparate commands. In one embodiment, the systems and of the present application may function to implement an intervention gateway that intelligently arbitrates between manual control commands and autonomous control commands. In such embodiment, one or more of an identification of non-nominal manual control values and/or a detection of a manual takeover signal may function to trigger a lockout of a computer or autonomous control of an autonomous agent and ceding full or substantially full control of the autonomous agent to a human operator of the like.

### 2. System for Intelligent Arbitration of Control Commands

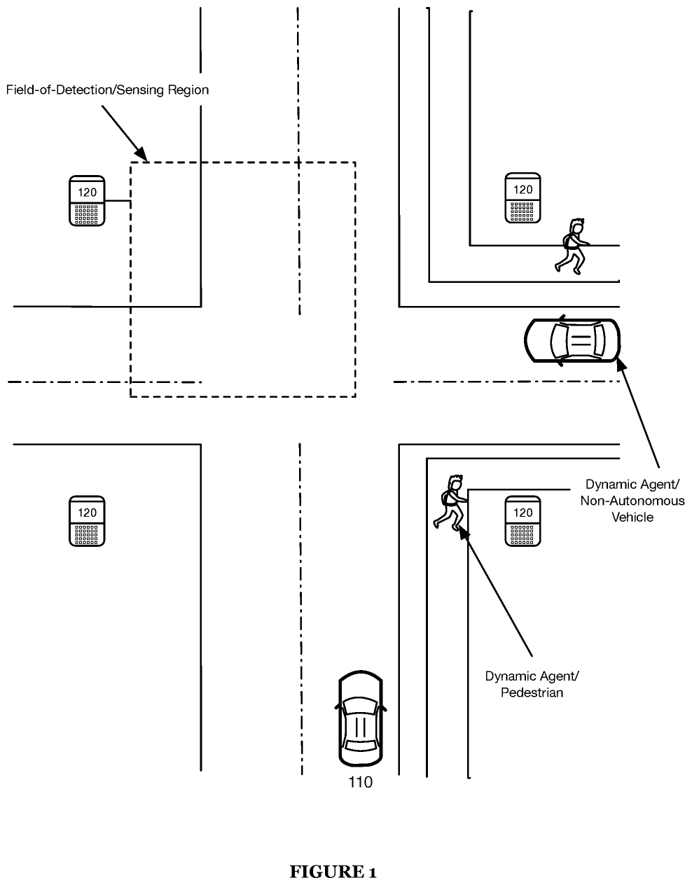

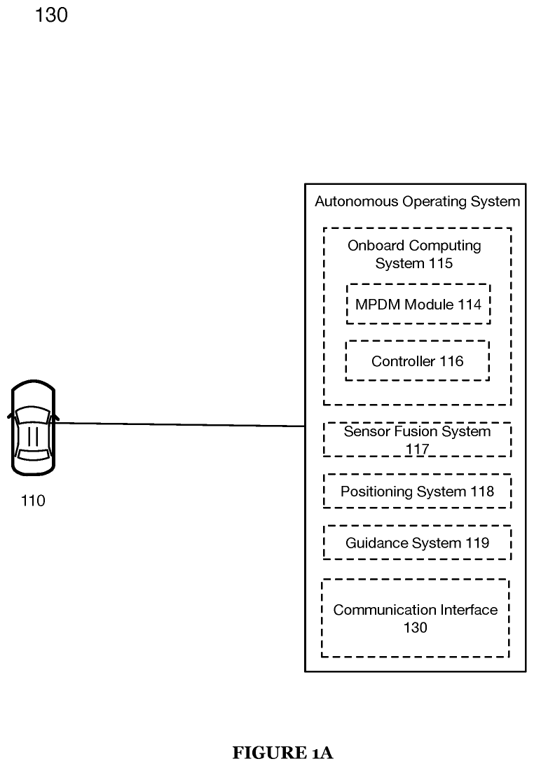

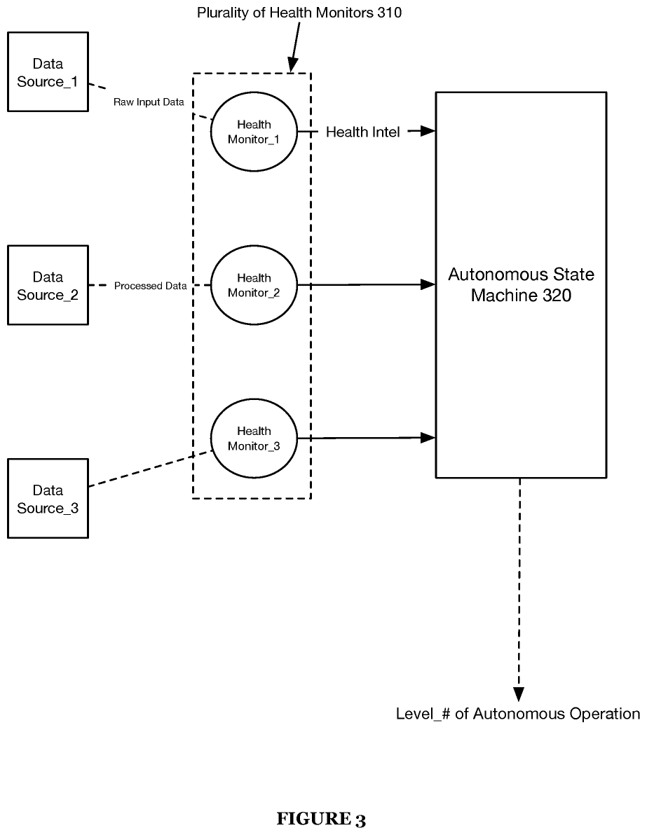

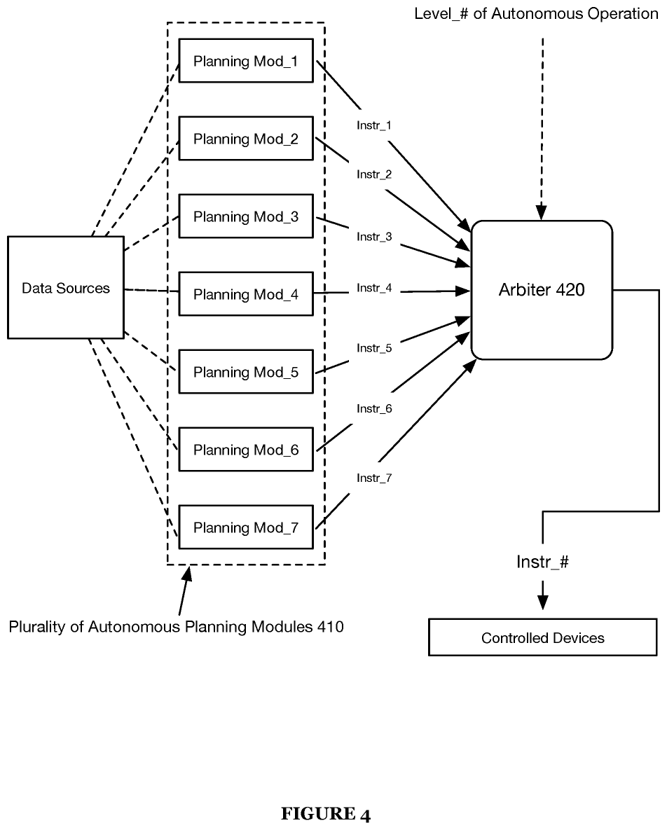

As shown in FIGS. 1-1A, a system 100 for intelligently implementing an autonomous agent that includes an autonomous agent 110, a plurality of infrastructure devices 120, and a communication interface 130. As shown in FIG. 3, a subsystem 300 of the system 100 includes a plurality of autonomous health monitors 310 and an autonomous state machine 320. Further, as shown in FIG. 4, a subsystem 400 of the system 100 includes a plurality of autonomous control planning module s 410 and an arbiter of autonomous control instruction 420.

The autonomous agent 110 preferably includes an autonomous vehicle 110 that is preferably a fully autonomous vehicle, but may additionally or alternatively be any semi-autonomous or fully autonomous vehicle; e.g., a boat, an unmanned aerial vehicle, a driverless car, etc. Additionally, or alternatively, the autonomous agent no may be a vehicle that switches between a semi-autonomous state and a fully autonomous state (or a fully-manned state) and thus, the autonomous agent no may have attributes of both a semi-autonomous vehicle and a fully autonomous vehicle depending on the state of the autonomous agent no. While some portions of the embodiments of the present application are described herein as being implemented via an autonomous agent no (e.g., an autonomous vehicle (e.g., a driverless car), a semi-autonomous, an unmanned aerial vehicle (e.g., a drone), or the like) it shall be noted that any suitable computing device (e.g., any edge device including mobile computing devices, etc.) may be implemented to process sensor data of an autonomous agent no. While it is generally described that the autonomous agent 110 may be an autonomous vehicle, it shall be noted that the autonomous agent no may be any type of kind of autonomous machine, autonomous device, autonomous robot, and/or the like.

In a preferred embodiment, the autonomous agent no includes an onboard computing system 115 (e.g., a computer integrated with the autonomous agent) or any suitable vehicle system but can additionally or alternatively be decoupled from the autonomous agent no (e.g., a user mobile device operating independent of the autonomous agent).

Additionally, or alternatively, the onboard computing system 115 may include a processing system (e.g., graphical processing unit or GPU, central processing unit or CPU, or any suitable processing circuitry) as well as memory. The memory can be short term (e.g., volatile, non-volatile, random access memory or RAM, etc.) and/or long term (e.g., flash memory, hard disk, etc.) memory. As discussed below, the autonomous agent 110 may additionally include a communication interface 130 that includes a wireless communication system (e.g., Wi-Fi, Bluetooth, cellular 3G, cellular 4G, cellular 5G, multiple-input multiple-output or MIMO, one or more radios, or any other suitable wireless communication system or protocol), a wired communication system (e.g., modulated powerline data transfer, Ethernet, or any other suitable wired data communication system or protocol), sensors, and/or a data transfer bus (e.g., CAN, FlexRay).

Additionally, or alternatively, the autonomous agent no may be in operable communication with a remote or disparate computing system that may include a user device (e.g., a mobile phone, a laptop, etc.), a remote server, a cloud server, or any other suitable local and/or distributed computing system remote from the vehicle. The remote computing system is preferably connected to one or more systems of the autonomous agent through one or more data connections (e.g., channels), but can alternatively communicate with the vehicle system in any suitable manner.

The onboard computing system 115 preferably functions to control the autonomous agent no and process sensed data from a sensor suite (e.g., a computer vision system, LiDAR, flash LiDAR, wheel speed sensors, radar, GPS, etc.) of the autonomous agent 110 and/or other (infrastructure device 120) sensors to determine states of the autonomous agent 110 and/or states of agents in an operating environment of the autonomous agent 110. Based upon the states of the autonomous agent and/or agents in the operating environment and programmed instructions, the onboard computing system 115 preferably modifies or controls behavior of autonomous agent 110. Additionally, or alternatively, the onboard computing system 115 preferably includes a multi-policy decision-making module 114 that functions to generate behavioral policies and select a behavioral policy that the onboard computing system 115 may function to execute to control a behavior of the autonomous agent 110.

The onboard computing system 115 is preferably a general-purpose computer adapted for I/O communication with vehicle control systems and sensor systems but may additionally or alternatively be any suitable computing device.

Additionally, or alternatively, the onboard computing system 115 is preferably connected to the Internet via a wireless connection (e.g., via a cellular link or connection). Additionally, or alternatively, the onboard computing system 115 may be coupled to any number of wireless or wired communication systems.

The infrastructure devices 120 preferably function to observe one or more aspects and/or features of an environment. In such preferred embodiments, the infrastructure devices additionally function to collect data associated with the observations and transmit the collected data and/or processed derivatives of the collected data to the autonomous agent 110. Additionally, or alternatively, each of the infrastructure devices 120 may function to generate health status data based on continuous and/or periodic introspective evaluations of one or more operations, processes, operable features, and the like of the respective introspective device 120. The infrastructure devices 120 may function to transmit the health status data separately from and/or along with sensed data (observation data). In some embodiments, the infrastructure devices 120 may be referred to herein as roadside units. The roadside units preferably include devices in an immediate and/or close proximity to an operating position of an autonomous agent 110, such as an autonomous car, and may function to collect data regarding circumstances surrounding the autonomous agent 110 and in areas proximate to a zone of operation of the autonomous agent no. In some embodiments, the roadside units may include one or more of offboard sensing devices including flash LiDAR, thermal imaging devices (thermal cameras), still or video capturing devices (e.g., image cameras and/or video cameras, etc.), global positioning systems, radar systems, microwave systems, inertial measuring units (IMUs), and/or the like.

The infrastructure devices 120 may additionally or alternatively include computing capabilities via processing circuitry and a communication interface that enables the infrastructure devices 120 to communicate with an autonomous agent 110.

A technical benefit achieved by the implementation of the infrastructure devices 120 includes an ability to observe circumstances (e.g., around corners, down perpendicular streets, etc.) beyond the observable scope of the autonomous agent no. The autonomous agent 110 may function to augment data derived by its own onboard sensor suite with the additional observations by the infrastructure devices 120 (e.g., the roadside) 120 to improve behavioral policy selection by the autonomous agent 110.

Additionally, or alternatively, in various embodiments the infrastructure devices 120 are able to detect and track any type or kind of agents in an operating environment, such as with a video camera or radar. In such embodiments, an example video camera may function to provide detection of agents and semantic classification of the agent type and possible intent of an agent, such as a pedestrian that is about to cross a road, or a car that is about to make a left turn, a driver which is about to open a car door and exit their vehicle and/or the like.

Additionally, or alternatively, other infrastructure devices 120 may include traffic management devices or the like operating in the environment that may function to communicate with one or more of the roadside units and/or communicate directly with the autonomous agent regarding data collected and/or sensed by the infrastructure device, regarding an operating state of the infrastructure device (e.g., red or green traffic light), and the like. For example, in the case that the autonomous agent 110 is an autonomous vehicle, a traffic light may be an infrastructure device in an environment surrounding the autonomous vehicle that may function to communicate directly to the autonomous vehicle or to a roadside unit that may be in operable communication with the autonomous vehicle. In this example, the traffic light may function to share and/or communicate operating state information, such as a light color that the traffic light is projecting, or other information, such as a timing of the light changes by the traffic light, and/or the like.

The communication interface 130 preferably enables the autonomous agent no to communicate and/or exchange data with systems or devices external to the autonomous agent no. Preferably, the communication interface 130 enables one or more infrastructure devices 120 to communicate directly with the autonomous agent no. The communication interface 130 preferably includes one or more of a cellular system (or any suitable long-range communication system), direct short-wave radio, or any other suitable short-range communication system. Additionally, or alternatively, the communication interface 130 may function to enable inter-vehicle communication between the autonomous agent no and other vehicles, including fully autonomous vehicles, semi-autonomous vehicles, and manual vehicles.

In some embodiments, in addition to a powertrain (or other movement-enabling mechanism), autonomous agent no may include a sensor suite (e.g., computer vision system, LiDAR, RADAR, wheel speed sensors, GPS, cameras, etc.) or onboard sensors that are in operable communication with the onboard computing system 115.

The sensor suite preferably includes sensors used to perform autonomous agent operations (such as autonomous driving) and data capture regarding the circumstances surrounding the autonomous agent 110 as well as data capture relating to operations of the autonomous agent 110 but may additionally or alternatively include sensors dedicated to detecting maintenance needs of the autonomous agent no. For example, the sensor suite may include engine diagnostic sensors or an exterior pressure sensor strip. As another example, the sensor suite may include sensors dedicated to identifying maintenance needs related to cleanliness of autonomous agent interiors; for example, internal cameras, ammonia sensors, methane sensors, alcohol vapor sensors, etc.

In accordance with one or more embodiments, an autonomous operating system may generally include a controller 116 that controls autonomous operations and/or actions of the autonomous agent 110. That is, suitable software and/or hardware components of controller 116 (e.g., processor and computer-readable storage device) are utilized to generate control signals for controlling the autonomous agent 110 according to a routing goal of the autonomous agent 110 and selected behavioral policies of the autonomous agent.

Additionally, or alternatively, the autonomous agent 110 includes a sensor fusion system 117, a positioning system 118, and a guidance system 119. As can be appreciated, in various embodiments, the instructions may be organized into any number of systems (e.g., combined, further partitioned, etc.) as the disclosure is not limited to the present examples.

In various embodiments, the sensor fusion system 117 synthesizes and processes sensor data and predicts the presence, location, classification, and/or path of objects and features of the environment of the autonomous agent 110. In various embodiments, the sensor fusion system 117 may function to incorporate data from multiple sensors and/or data source, including but not limited to cameras, LiDARs, radars, infrastructure devices, remote data feeds (Internet-based data feeds), and/or any number of other types of sensors.

The positioning system 118 preferably processes sensor data along with other data to determine a position (e.g., a local position relative to a map, an exact position relative to lane of a road, vehicle heading, velocity, etc.) of the autonomous agent no relative to the environment. The guidance system 119 processes sensor data along with other data to determine a path for the vehicle 110 to follow.

In various embodiments, the controller 116 may function to implement machine learning techniques to assist the functionality of the controller 116, such as feature detection/classification, obstruction mitigation, route traversal, mapping, sensor integration, ground-truth determination, and the like.

The plurality of autonomous health monitors 310 preferably function to evaluate data streams from any data source associated with an operation and/or control of an autonomous agent no and output autonomous health intelligence data. In one embodiment, autonomous health intelligence data may relate to a judgement by each of the autonomous health monitors regarding a state of health of each of the devices and/or operations that produce the data streams. In one embodiment, each of the plurality of autonomous health monitors 310 may be configured to evaluate a different data stream originating from different data source s. For instance, a first data stream from a first device may be evaluated by a first autonomous health monitor and a second data stream from a second process or operation may be evaluated by a second autonomous health monitor and the like.

Each of the plurality of autonomous health monitors 310 may be in operable communication with the autonomous state machine 320. The autonomous state machine preferably functions to consume the autonomous health intelligence data as well as state data from any suitable source (e.g., from the plurality of autonomous control planning module s 410 or the like). In a preferred embodiment, the autonomous state machine 320 may be a device that is separate and distinct from the onboard computer 115 and may function to calculate an operating state or a level of operability (e.g., runlevel) of an autonomous agent based on inputs of health data. The operating state and/or the level of operability preferably includes a value that indicates an extent to which the capabilities and/or functionalities of autonomous agent are operable or not operable (e.g., runlevel 7=100% operability, runlevel 6=90% operability, and/or the like). While it may be generally described that a given level of operability may be associated with a percentage level of operability of an autonomous agent, it shall be noted that a level of operability shall not be restricted to such example, but may additionally or alternatively include embodiments in which a health system (e.g., health monitors) of the autonomous agent evaluates capabilities and/or operability of the autonomous agent's systems, and identifies a level of operability based on this evaluation.

It shall be noted that while the autonomous state machine 320 may be implemented independently of an onboard computer 115 of an autonomous agent 110, the autonomous state machine 320 may be integrated with any suitable device and/or system of an autonomous agent 110 including the onboard computer 115.

The plurality of autonomous control planning module s 410 preferably function to generate a plurality of autonomous control instructions for an autonomous agent 110. Accordingly, each of the plurality of autonomous control planning module s 410 may function to output different autonomous control instructions or plans that correspond to different level of operability of an autonomous agent.

Additionally, each of the plurality of autonomous control planning module s 410 may be configured to continuously collect data streams from a plurality of data source s (e.g., onboard and offboard data source s) and run in parallel to continuously simulate one or more trajectory outcomes for an autonomous agent 110 and correspondingly, generate autonomous control instructions based on a simulation having a highest probability of occurring, as described in U.S. Provisional Application No. 62/701,014, which is incorporated by this reference in its entirety.

### 2.1 Arbiter of Autonomous Control Instructions

As described in U.S. Provisional Application No. 62/702,715, which is incorporated by this reference in its entirety, the arbiter of autonomous control instructions 420 preferably functions to collect, as input, the plurality of autonomous control instructions from the plurality of autonomous planning module s 410 as well as receive, as input, data relating to an identified level of operability from the autonomous state machine 310. Based on the input of the level of operability of the autonomous agent 110, the arbiter 420 may function to selectively enable only a subset of the plurality of autonomous control instructions to pass to lower level devices and/or operating components of an autonomous agent 110. For instance, if an input of runlevel_3 (out of seven possible runlevels) is received from the autonomous state machine, the arbiter may function to selectively allow only autonomous control instructions (e.g., autonomous control instructions_3 from planning module_3) mapped to runlevel_3 to pass as command instructions for operating one or more devices of the autonomous agent.

Additionally, or alternatively, the arbiter 420 may be configured with selection circuitry or the like that enables the arbiter 420 to selectively pass valid autonomous control instructions for controlling the autonomous agent 110 and also, block invalid autonomous control instructions. In one embodiment, the selection circuitry includes a switch that operably switches between autonomous control instructions based on an input of the level of operability and/or based on an input of a manual takeover signal or the like. In another embodiment, the selection circuitry includes a plurality of filters that may be selectively activated for filtering autonomous control instructions and allowing only select autonomous control instructions to pass based on an input of the level of operability.

### 2.2 Manual Intervention Gateway

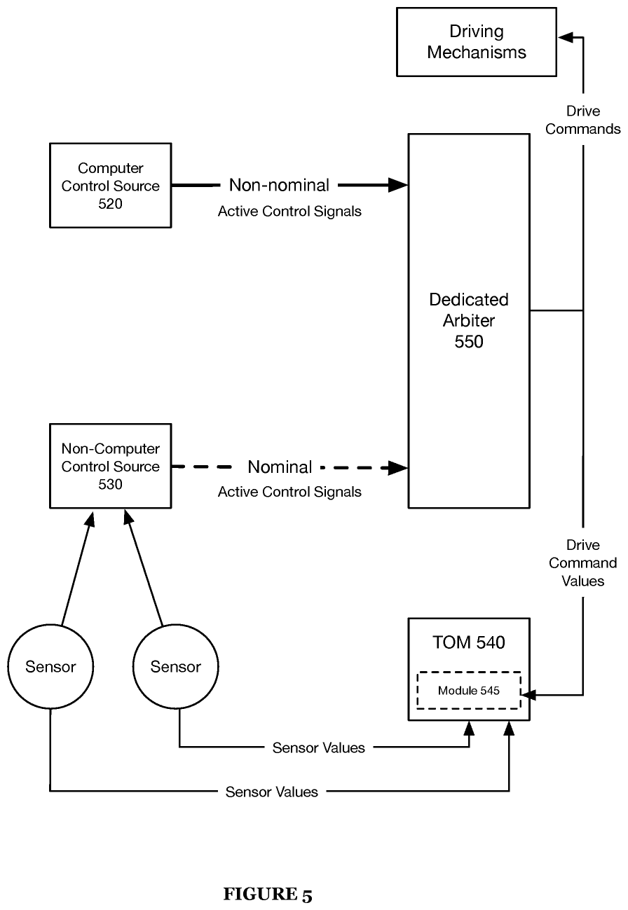

As shown in FIG. 5, the system 100 for intelligently implementing an autonomous agent no may additionally include a subsystem 500 that enables the autonomous agent no to transition from an autonomous mode (computer-controlled) of operation to a manual mode of operation based on a detected manual intervention by a human operator or the like while an autonomous driving operation of the autonomous agent 110 is active. The subsystem 500 preferably includes two or more drive command source s including a computer control source (e.g., onboard computer system 115 or the like) 520 and a non-computer control source or source s 530, a takeover signal module 540, and a dedicated arbiter of active control signals 550.

In a preferred embodiment, the dedicated arbiter of active control signals 550 functions to arbitrate between active control signals (drive commands) from the (autonomous) computer control source 520 and the non-computer control source 530. The dedicated arbiter of active control signals 550 may sometimes be referred to herein as a manual intervention gateway as a recurring functionality of the dedicated arbiter 550 includes enabling a manual intervention by a human operator and acting as a gateway that passes drive commands from a human source or non-computer control source for controlling the autonomous agent 110.

An arbitrating operation or switching operation of the dedicated arbiter of active control signals 550 may preferably be triggered by a detection or a receipt of a takeover signal from the takeover signal module 540 (or any other suitable takeover action, takeover condition, or takeover signal source). The takeover signal module 540 preferably functions to generate a takeover signal in response to detecting manual input from a human interface component or a driving mechanism of the autonomous agent 110 while the autonomous agent is operating in an autonomous mode (i.e., self-driving, computer-controlled, etc.).

Additionally, or alternatively, the takeover signal module 540 may function to implement a monitoring/tracking module 545 that monitors one or more behaviors of the autonomous agent 110, one or more interactions and/or actions performed by a human operator or the like with the autonomous agent no, one or more calibration and/or baseline values associated with one or more driving mechanisms (e.g., acceleration pedal, braking pedal, steering wheel, etc.) of the autonomous agent 110, and the like. The one or more driving mechanisms may include any user interface component of the autonomous agent that operably enables a human user to interact with and/or control one or more driving operations (e.g., On/Off, stop/start, velocity, acceleration, turning, direction, etc.) of the autonomous agent.

Additionally, or alternatively, the monitoring module 545 may additionally function to collect and/or track state data relating to one or more subsystem s (e.g., subsystem 400, runlevel data, etc.) of the autonomous agent 110 as well as relating to specific driving mechanisms and the computer control source of the autonomous agent 110. The takeover signal module 540 may function to use data collected and/or derived by the monitoring module 545 to detect a manual intervention and/or a takeover event or condition that may cause the takeover signal module 540 to generate a takeover control signal.

As one example, the monitoring module 545 may function to monitor baseline and/or calibrated values (computer-set values, nominal position values, or the like) for each of a number of driving mechanisms of an autonomous agent 110. In the case that the autonomous agent is operating in an autonomous mode and being controlled by a computer control source 520 or the like, the sensor values (sensed values) from the number of driving mechanisms should match or be substantially the same as command values from a computer control source for each of the driving mechanisms. If the sensed values tracked by the monitoring module 545 obtained from one or more sensors associated with the number of driving mechanisms do not match or substantially match the command values from the computer control source 520, the monitoring module 545 may function to compute state data for the driving mechanisms and based on the state data, the takeover signal module 540 may function to generate a takeover control signal based on the mismatch between the command and sensed values (calibrated values, nominal values, baseline values, or the like). That is, in one or more embodiments, the monitoring module 545 may operate to compute state data any driving mechanism of the autonomous agent where the state data may include a state value or the like representing a difference between a baseline value or calibrated (i.e., unoperated valued) of a given driving mechanism and a sensed value for the given driving mechanism. In such embodiment, if the computed state value meets or exceeds some predetermined or dynamically determined takeover threshold value, the takeover signal module 540 may respond with a production of a takeover signal to the dedicated arbiter 550.

In one embodiment, the system may include redundant sensors on each of the driving mechanisms and/or user driving interface components of the autonomous agent. For instance, in one or more embodiments, user driving interface components, such as a brake pedal, an acceleration pedal, a steering wheel or the like may include at least two sensors. In such circumstances, if the monitoring module 545 detects and/or identifies a non-zero or non-nominal control value at a first sensor of a given user driving interface component, the monitoring module 545 may operating to validate or check the control value from the first sensor to a control value of a second sensor of the given driving interface component. If the control values of both the first and the second sensor match, the takeover signal module 540 may function to generate a takeover signal based on the computed match. However, in some embodiments, if the control values of the first and the second sensor do not match, the takeover signal module 540 may function to assess the higher control value of the first and the second sensor and compute whether the higher control value is sufficient to trigger a takeover signal. That is, the takeover signal module 540 may function to assess the higher control value against a minimum control value threshold that if met or exceeded by the higher control value may function to trigger a takeover control signal even if the first and the second sensor values do not match.

Additionally, or alternatively, once a takeover signal or event is detected or computed, the dedicated arbiter of active control signals 550 may function to implement a lockout of the computer control source 520 thereby preventing drive commands published by the computer control source 520 from being executed by lower level devices and/or driving mechanisms of the autonomous agent 110. Accordingly, the lockout mechanism enables full driving control of the autonomous agent 110 by a human operator or the like without intervention by the computer control source 520 in response to a manual takeover attempt by the human operator and/or in response to a takeover condition or event.

Preferably, the dedicated arbiter of active control signals 550 comprises a dedicated piece of hardware separate and distinct from the onboard computer 115. Alternatively, in some embodiments, the dedicated arbiter of active control signals 550 may be integrated with the onboard computer 115, such that the functionalities and/or operations of the dedicated arbiter 550 may be performed by one or more components and/or module s of the onboard computer 550.

### 3. Method for Intelligent Arbitration of Drive Commands

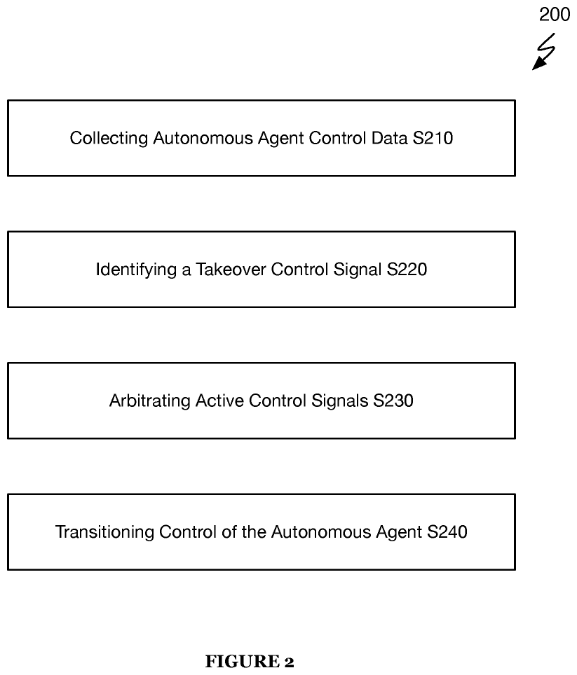

As shown in FIG. 2, a method 200 for automatically enabling manual control of an actively computer-controlled autonomous agent includes receiving autonomous agent control data S210, identifying a takeover control signal S220, arbitrating driving commands for controlling the autonomous agent S230, and locking out a computer control source S240.

S210, which includes receiving autonomous agent control data, functions to receive from one or more autonomous agent control source s (control source s) active control signals for controlling one or more operations (e.g., driving operations) of an autonomous agent. In a preferred embodiment, S210 may function to receive autonomous agent control data from at least two autonomous agent control source s including an autonomous agent control computer (e.g., a computer controller or a computer control source) and a non-computer control source (e.g., a manual controller or a human control source). Additionally, or alternatively, S210 may function to receive autonomous agent control data from a dedicated takeover signal source (e.g., takeover module 540) that preferably relates to and/or functions to generate a signal or command instructions indicating that a non-computer control source is attempting to obtain or has obtained manual control of the autonomous agent.

A computer controller or a computer control source preferably relates to a computer-implemented controlling entity, such as an onboard computer or a remote computing server (implemented via a distributed computing system or the like), of an autonomous agent that may function to automatically generate control instructions for operating the autonomous agent based on a routing objective/goal or operating objective of the autonomous agent. Thus, in one or more embodiments, the computer control source enables self-driving of the autonomous agent.

On the other hand, a manual control source preferably relates to a human or non-computer implemented entity that may function to control the autonomous agent via physical or manual interactions or inputs from the human and/or non-computer implemented entity. Thus, in some embodiments, the manual control source may function to manipulate any user driving interface components of the autonomous agent including one or more of a steering mechanism, accelerator pedal or mechanism, and/or a braking pedal or mechanism to manually control the autonomous agent.

Additionally, or alternatively, it shall be noted that a manual control source may include acoustic or sound-based controls (e.g., voice controls or the like) and/or gesture-based controls, which may or may not cause physical manipulations of the user driving interface components of an autonomous agent but nevertheless act as a manual control of the autonomous agent by a user.

In a preferred embodiment, as shown by way of example in FIG. 5, each of the computer control source and the non-computer control source may function to continuously generate an active control signal stream that includes active control signals for controlling one or more operations of an autonomous agent. The active control signal stream generated by the computer control source may originate from a controlling computer per se and may typically include instructions or command signals for controlling one or more (driving) operations (e.g., braking, acceleration, steering, etc.) of an autonomous agent. The active control signal generated by the non-computer control source or manual control source may originate from one or more (human) interface control components or devices (e.g., a steering mechanism or wheel, a brake pedal, an acceleration pedal, physical or digital buttons, etc.) or microcontrollers associated therewith of an autonomous agent. In such instances, input to or a manipulation of the one or more interface control components or devices may function to generate a signal value that may be converted (by a microcontroller or the like) to an active control signal for controlling one or more operations of an autonomous agent. For example, a human operator may function to provide a manual input to a steering mechanism (such as a steering bar or steering wheel) of an autonomous agent. In such example, a steering sensor may function to measure a steering angle that may be converted into an active control signal for causing the autonomous agent to steer in a direction consistent with the manual input by the human operator. Still in such instance, the steering angle measurement may be converted to an active control signal by a local microcontroller or processing circuit or the like that may generally function to convert measurements of physical or manual inputs into active control signals (or computer-comprehensible control signals, etc.).

Accordingly, in an active state (e.g., an ON state, a DRIVING state, etc.) of an autonomous agent, a computer control source and a non-computer control source may function to generate distinct streams of active control signals (i.e., a computer signal stream and a non-computer signal stream) that may be provided to and received by at least a manual intervention gateway or a dedicated arbiter of active control signal (e.g., dedicated arbiter 550). Preferably, the streams of active control signals by the computer control source and the non-computer control source operate in parallel, such that the dedicated arbiter of active control signal may function to receive the continuous or periodic active control signals from both of the distinct control signal source s at a same time (i.e., simultaneously).

S220, which includes identifying autonomous agent takeover, functions to detect or identify that a non-computer entity or non-computer controlling source is attempting to acquire or has acquired operational control of the autonomous agent. That is, S220 preferably functions to detect an attempt to transfer driving operational control of the autonomous agent from a computer control source or computer controlling entity to a non-computer controlling entity (e.g., a human operator). In such instances, an operational control of an autonomous agent preferably relates to driving operational control of the autonomous agent, but may additionally, or alternatively relate to any type of control or operation of an autonomous agent including non-driving operations of the autonomous agent.

In an autonomous operating scenario in which an autonomous agent is operating in a first, autonomous mode, a computer controlling entity or computer control source may function to fully control driving operations (e.g., steering, braking, and acceleration) of the autonomous agent without human intervention. That is, in such embodiments, the computer controlling entity functions to instruct and cause a physical drive of the autonomous agent to achieve a routing objective and/or any suitable driving goal. In such scenario, the active control signals from the computer controlling entity (computer control source) may include various control values for each of the driving mechanisms (e.g., brake pedals, acceleration pedal, steering wheel, etc.) of the autonomous agent that eventually controls one or more lower level components and/or devices (e.g., a physical brake application, a throttle opening size, a steering angle, etc.) of the autonomous agent. Accordingly, the active control signal from the computer controlling entity may include non-nominal values and/or at least one non-zero control value for at least one of the driving mechanism of the autonomous agent. Correspondingly, in this typical autonomous operating scenario in which the autonomous agent is operating in the first, autonomous mode, the active control signals from the non-computer controlling source may include control values for each of the driving mechanisms that are all nominal and/or zero or otherwise, control values that are insufficient for actuating driving operations of the autonomous agent.

A nominal control value, as generated by a computer control source or a non-computer control source, preferably includes a generated control value that does not satisfy or falls below a minimum threshold for an executable control value. That is, a nominal control value may represent a control signal or value that is very small, below an actuation threshold, or that is zero and thus, may be insufficient for executing an operational control of an autonomous agent. By contrast, a non-nominal control value may be a generated control value that satisfies or exceeds a minimum threshold for an executable control value. For example, a non-computer control source may function to generate active control signals having nominal control values for each of a braking mechanism (brake pedal) and an accelerating mechanism (acceleration pedal) for an autonomous agent when the braking mechanism and the accelerating mechanism are at a standard (nominal) position and/or in an unactuated state or position by a human operator or the like. However, in a counter example, the non-computer control source may function to generate active control signals having non-nominal control values for one or more of the braking mechanism and the accelerating mechanism for the autonomous agent when either or both the accelerating mechanism and the braking mechanism are moved from a standard position and/or are placed in an actuated position or state by a human operator. It shall be understood that active control signals having nominal or non-nominal values may be generated for any suitable human interface mechanism of an autonomous agent.

In one implementation, depending on an operating state of the autonomous agent, either the non-computer control source or the computer control source may be in an idle state, such that either the non-computer control source or the computer control source does not emit any active control signals unless specifically triggered by an activation signal (e.g., depressing autonomous mode button, physically actuation of human interface device, or the like).

Additionally, or alternatively, in a manual operating scenario in which an autonomous agent is operating in a second, manual operating mode, a non-computer controlling entity or source may function to control driving operations of the autonomous agent. In such scenario, the active control signals from the non-computing control entity or source may include various control values for each of the driving mechanisms of the autonomous agent that include non-nominal and/or at least one non-zero value sufficient for actuating one or more driving mechanisms of the autonomous agent. In such manual operating mode, a computer control source may function to continue publishing active control signals with non-nominal and/or non-zero values for controlling the autonomous agent. However, as discussed in more detail in S230, the active control signals from both of the computer controlling source and the non-computing controlling source may be arbitrated by a dedicated arbiter of autonomous control signals or the like such that only the active control signals having a non-nominal value from the non-computer controlling source may be recognized for controlling the autonomous agent.

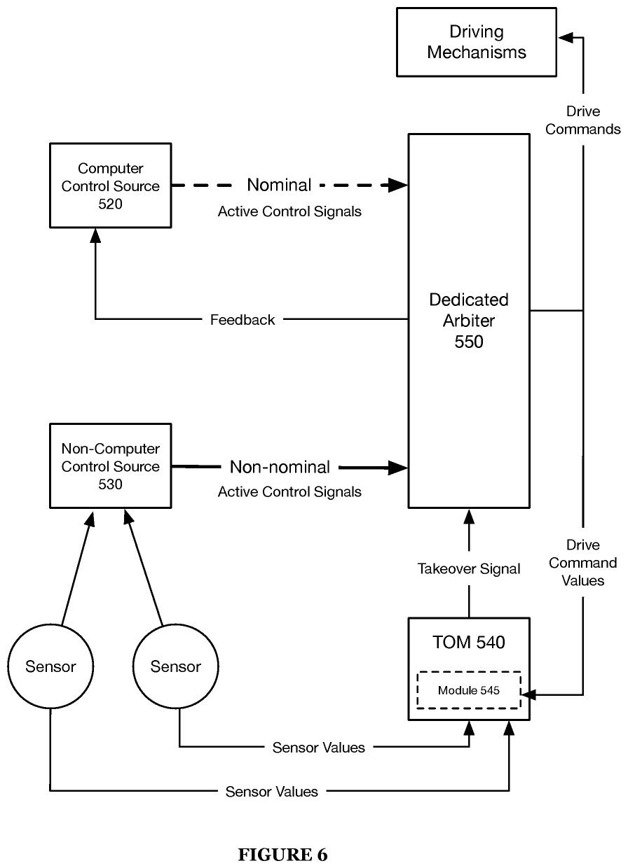

In a first implementation, S220 may function to detect or identify that a non-computer controlling entity or a non-computer control source is attempting to acquire or has acquired manual control of an autonomous agent based on a detection of a takeover control signal. A takeover control signal preferably indicates that, while the autonomous agent was being controlled by a computer control source, one or more driving mechanisms of the autonomous agent has been physically manipulated or actuated by a non-computer controlling entity to potentially control driving operations of the autonomous agent. As shown by way of example in FIG. 6, a takeover control signal may be received at a dedicated arbiter of active control signals or the like along with the active control signals from a computer control source and the non-computer control source.

In this first implementation, the takeover control signal may be generated in any suitable manner including, but not limited to, based on a detection of an active control signal from a non-computer controlling source in which the active control signal includes non-nominal control values and/or non-zero control values for one or more driving mechanisms of the autonomous agent. For example, if a human operator physically manipulates a driving mechanism, such as a steering wheel, a sensor and/or microcontroller associated with the steering wheel may function to produce an active control signal having a control value having a non-nominal or a non-zero value (or a value greater than a standard or nominal position of the steering wheel) indicating that the steering wheel has been manipulated by the human operator. In such instance, a detection of the non-nominal and/or non-zero control value for the steering mechanism while the autonomous agent is under computer control may function to trigger a generation of a takeover control signal. Accordingly, a physical operation of a driving mechanism of the autonomous agent may function to generate at least two control signals including an active control signal and a takeover control signal. In some embodiments, the active control signal and the takeover control signal may be generated by a same source, such as a non-computer control source. Alternatively, the active control signal, in such instance, may be generated by the non-computer control source and the active control signal by a distinct source, such as a takeover control module or the like.

In a second implementation, S220 may function to implicitly detect or identify (i.e., without or separately from an explicit control signal) that a non-computer controlling entity or a non-computer controlling source is attempting to acquire or has acquired manual control of an autonomous agent based on a detection of one or more control signals having non-nominal values from a non-computer control source. In this second implementation, S220 may function to monitor the control values of the active control signals originating with a non-computer control source and continuously or periodically compare the received controls values to control values or command values generated by a computer control source of an autonomous agent while the autonomous agent is in an autonomous mode. In one example, while operating an autonomous agent in an autonomous mode, a computer control source may generate active control signals with nominal control values (e.g., 0) for a braking mechanism of an autonomous agent and a non-computer control source may generate active control signals with non-nominal control values (e.g., 50) for the braking mechanism. In this example, S220 may function to identify an attempt for takeover of the autonomous agent based on the disparity (mismatch) between the control values of the active control signals of the computer control source and the non-computer control source. In some embodiments, while an autonomous agent is operated in an autonomous state, S220 may function to operate under one or more assumptions or conditions including that the control values of the active control signals from the non-computer controls source should be equal to or less than the control values of the active control signals from the computer control source. In such embodiments, if the comparison of the control values from the computer control source and the non-computer control source violates or does not satisfy the assumption or condition, then S220 may function to detect or identify an attempt to take over control of the autonomous agent by a human operator or the like.

In a third implementation, S220 may function to automatically trigger a generation of a takeover control signal based on an identification or detection of a predetermined takeover event or condition. Generally, a predetermined takeover event or condition relates to an event or condition identified within an enumerated list of events or conditions in which autonomous control of an autonomous agent is less desirable than human control of the autonomous agent. One or more examples of predetermined events or conditions include the autonomous agent arriving at an edge of its navigational map, an identification or detection of a degraded level of operability (runlevel), a complex parking circumstance, an emergency or urgent situation, and any other suitable circumstance in which a degree of confidence in decisioning control decision by a computer control source is low and/or a probability of successfully controlling the autonomous agent by a computer control source is low or the like.

S230, which includes arbitrating active control signals, functions to arbitrate between active control signals from a computer control source and active control signals from a non-computer control source, preferably, based on a takeover control signal and/or detecting a takeover control event/condition. S230, preferably functions to arbitrate between the computer and non-computer active control signals using a dedicated arbiter of active control signals (e.g., dedicated arbiter 550).

In a first mode (e.g., pass-through tracking mode), the dedicated arbiter of active control signals may function to pass active control signals from a computer control source to driving mechanisms (and various lower level hardware or devices) of an autonomous agent while performing one or more monitoring and/or tracking functions of driving operations of the autonomous agent. In this first mode, for example, the dedicated arbiter of active control signals may function to track positions of one or more driving mechanisms (e.g., steering angles, wheel positions, etc.), one or more sensor values associated with the one or more driving mechanisms (e.g., torque values, braking values, accelerator values), and the like thereby verifying that the control values of the active control signals from the computer control source are being executed and that a takeover event and/or condition has not influenced the one or more driving mechanisms.

In a second mode (e.g., a takeover mode), the dedicated arbiter of active control signals may function to pass active control signals from a non-computer control source to driving mechanisms (and various lower level hardware or devices) of an autonomous agent and if previously in the first mode, terminate or stop passing active control signals from a computer control source to the driving mechanisms of the autonomous agent. The second mode of the dedicated arbiter of active control signals is preferably triggered by a receipt of a takeover signal and/or by a detection of a takeover event or condition by the dedicated arbiter. In this second mode, even if control values of the one or more driving mechanisms return to nominal values of the one or more driving mechanisms (e.g., before human intervention or switching from the first mode to the second mode), the dedicated arbiter of active control signals may function to remain in the second mode, in some embodiments, until an affirmative action (e.g., toggling a button for self-driving or an autonomous mode) is taken by a non-computer control source or human operator to revert back to the first mode of operation.

Accordingly, S230 may function to negotiate between a first mode and a second mode of operating the dedicated arbiter of active control signals to pass either active control signals from the computer control source or the active control signals from the non-computer (e.g., human operator) control source. In an autonomous mode of operating the autonomous agent, S230 may function to implement the dedicated arbiter of active control signals in the first mode, such that only active control signals from the computer passes to lower level devices and/or operating systems of the autonomous agent. In a manual mode of operating the autonomous agent in which human intervention or the like has been detected, S230 may function to implement the dedicated arbiter of active control signals, such that only active control signals from the non-computer passes to the lower level devices and/or systems of the autonomous agent.

As mentioned previously, S230 preferably functions to govern an operation of the dedicated arbiter of active control signals or negotiates between the first mode and the second mode of active control signal passing based on a detection of the takeover signal or other mode switching triggering event or condition.

In a first implementation, a takeover control signal may function to trigger a switch operation of a dedicated arbiter of active control signals or the like that causes the autonomous agent to transition from a first autonomous mode to a second manual or non-autonomous mode. In some embodiments, a switch associated with the switch operation may be a physical circuit switch that electrically governs which of the active control signals from a computer control source and a non-computer control source that passes through the dedicated arbiter though to driving mechanisms of the autonomous agent. Preferably, however, the switch operation may be implemented via a software application or software module that may function to selectively allow the passing of either the active control signals from a computer control source or active control signals from a non-computer control source through to driving mechanisms of the autonomous agent. In one example in which an autonomous agent is initially operating in an autonomous mode, in response to a receipt of a takeover control signal, S230 may implement the switch operation to selectively allow only active control signals from an intervening source or non-computer control source to pass through the dedicated arbiter of active control signals to one or more driving mechanisms of an autonomous agent.

In a second implementation, a takeover control signal may function to trigger a setting of active control signal filter that actively filters active control signals from one of the computer control source and the non-computer control source and allows to pass active control signals from the control source that is not actively filtered. Accordingly, in one embodiment, the dedicated arbiter of active control signals may implement a single filter module or the like with two operating modes that includes a first operating mode that filters out active control signals from the computer control source and a second operating mode that filters out active control signals from the non-computer control source. Additionally, or alternatively, in some embodiments, the dedicated arbiter of active control signals may implement multiple distinct filters including a first filter that filters out active control signals from the computer control source and a second filter that filters out active control signals from the non-computer control source.

In a third implementation, a takeover control signal may function to trigger an operation of a selector (module or the like) of a dedicated arbiter of active control signals that functions select between active control signals from a computer control source and from a non-computer control source. In a first autonomous operating mode of the autonomous agent, the selector may function to select only active control signals originating from a computer control source, however, upon a detection of a takeover event or condition, the selector may automatically function to select only active control signals from the non-computer control source. In such third implementation, the distinct active control signals may include metadata or the like that identifies the source of the signal such that the selector may function to select active control signals based on the appropriate source being identified by the metadata.

Additionally, or alternatively, in one or more embodiments, an operation of the dedicated arbiter of control signals for transitioning from the first autonomous mode of operating the autonomous agent to the second manual mode of operating the autonomous agent based on a takeover control signal or takeover event or condition may function to cause S230 to lockout a computer control source and effectively, ignore or otherwise, cancel out the active control signals from the computer control source. Additionally, or alternatively, S240 may function to generate a feedback signal to the computer control source indicating that the computer control source (e.g., onboard computer) does not have (driving) control of the autonomous agent. Accordingly, the computer control source may function to continue publishing active control signals having non-nominal control values, however, S240 may function to cause the dedicated arbiter or the like to ignore, not pass, or otherwise, fail to recognize those active control signals.

In a preferred embodiment, S240 automatically cedes control of the autonomous agent to a human operator or the like immediately or near immediately in response to a takeover control signal and/or in response to a detection of a takeover event or condition. Additionally, or alternatively, S240 may function to re-position one or more driving mechanism including one or more human interface devices to positions consistent with a state of one or more actuated lower level driving components of the autonomous agent, preferably during a transition for the autonomous operation mode to the manual operation mode of the autonomous agent. For instance, to mitigate a snap response of one or more human interface components, S240 may function to gradually re-position the one or more human interface components to allow a human operator or the like an opportunity to obtain full control of the human interface components for operating the autonomous agent. For instance, if the autonomous agent while under computer control was performing a turning operation when a human operator manually intervened with a braking operation, S240 may function to automatically cede control of the vehicle to the human operator, lockout the computer from controlling the autonomous agent, and further, slowly allow a steering mechanism of the autonomous agent to return to a nominal state from actuated turning state to avoid an immediate snap back or quick return of the steering mechanism to the nominal state.

The systems and methods of the preferred embodiments and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

Although omitted for conciseness, the preferred embodiments include every combination and permutation of the implementations of the systems and methods described herein.

As a person skilled in the art will recognize from the previous detailed description and from the figures and claims, modifications and changes can be made to the preferred embodiments of the invention without departing from the scope of this invention defined in the following claims.

What is claimed is:

1. A system for intelligently implementing an autonomous agent, the system comprising:
a computer-based control source that generates autonomous computer-based control signals for controlling a driving operation of an autonomous agent;
a non-computer control source that provides non-computer-based control signals for controlling the operation of the autonomous agent;
a dedicated arbiter of control signals that selectively passes one or more control signals from either the computer-based control source or the non-computer control source to one or more lower-level driving mechanisms of the autonomous agent; and
a takeover module that source s a takeover signal to the dedicated arbiter based on detecting one or more non-computer-based control signals having non-nominal control values from the non-computer control source,
wherein in response to the takeover signal, the dedicated arbiter dynamically switches from passing the autonomous computer-based control signals from the computer-based control source to passing non-computer-based control signals from the non-computer control source for controlling the one or more lower-level driving mechanisms of the autonomous agent.

2. The system according to claim 1, wherein:
the computer-based control source generates autonomous computer-based control signals enable a self-driving of the autonomous agent; and
the non-computer control source provides non-computer-based control signals that enable a full manual or a semi-manual driving of the autonomous agent by a human user.

3. The system according to claim 1, wherein
the one or more lower-level driving mechanisms of the autonomous agent include one or more components that, when actuated by a control signal, physical perform a driving action of the autonomous agent.

4. The system according to claim 1, wherein
the takeover signal relates to a signal or a command instruction indicating that a non-computer control source is attempting to obtain or has obtained manual control of the autonomous agent.

5. The system according to claim 1, wherein
in a first, autonomous operating mode of the autonomous agent:
(i) the computer-based control source fully controls the driving operations of the autonomous agent without human intervention,
(ii) the dedicated arbiter selectively passes only the computer-based control signals from the computer-based control source, and
(iii) the non-computer-based control signals from the non-computer control source include control values for each of the lower-level driving mechanisms that are nominal control values.

6. The system according to claim 5, wherein
in a second, manual operating mode of the autonomous agent:
(i) the non-computer control source controls the driving operations of the autonomous agent,
(ii) the dedicated arbiter selectively passes only the non-computer-based control signals from the non-computer control source, and
(iii) the non-computer control signals from the non-computing control source include control values for each of the lower-level driving mechanisms of the autonomous agent that include non-nominal control values.

7. The system according to claim 6, wherein
in the second, manual operating mode, the computer control source continues to publish computer-based control signals having non-nominal control values.

8. The system according to claim 6, wherein:
a nominal control value relates to a generated control value that does not satisfy or falls below a minimum control threshold for an executable control signal, and
a non-nominal control value relates to a generated control value that satisfies or exceeds the minimum control threshold.

9. The system according to claim 1, wherein
the takeover module generates the takeover signal based on detecting an actuation of one or more user driving interface components of the autonomous agent.

10. The system according to claim 1, wherein
in response to the takeover signal, the dedicated arbiter blocks the computer-based control signals from the computer-based control source to the one or more lower-level driving mechanisms of the autonomous agent.

11. The system according to claim 10, wherein
the dedicated arbiter generates a feedback signal to the computer-based control source indicating that the computer-based control source does not have driving control of the autonomous agent.

12. The system according to claim 10, wherein
the dedicated arbiter implements a lockout of the computer control source thereby preventing the computer-based control signals published by the computer-based control source from being executed by the lower level driving mechanisms of the autonomous agent.

13. The system according to claim 1, further comprising:
a monitoring module that identifies state data for each of a plurality of user driving interface components of the autonomous agent, wherein:
the monitoring module computes state data for each of the plurality of user driving interface components based on a difference between a calibrated value of a respective one of the plurality of user driving interface components and a sensed value for the respective one of the plurality of user driving interface components,
based on the computed state data, the takeover module generates the takeover signal when a control value associated with the computed state data for any of the plurality of driving mechanisms meets or exceeds a takeover threshold.

14. The system according to claim 1, wherein
the dedicated arbiter includes selection circuitry comprising a switch that operably switches between the computer-based control signals and the non-computer-based control signals based on an existence or a non-existence of the takeover signal.

15. The system according to claim 1, wherein
the driving operation relates to an action that changes a state of movement of the autonomous agent.

16. The system according to claim 1, wherein
a physical operation of a user driving interface component of the autonomous agent generates generate at least two distinct streams of control signals having non-nominal control values including the non-computer control signals and the takeover control signal.

17. The system according to claim 16, wherein
the takeover module is distinct from the non-computer control source.

18. A method for intelligently implementing an autonomous agent, the method comprising:
implementing a computer-based control circuit that generates autonomous computer-based control signals for controlling a driving operation of an autonomous agent;
enabling a non-computer control source that provides non-computer-based control signals for controlling the operation of the autonomous agent;
implementing a dedicated arbiter circuit that selectively passes one or more control signals from either the computer-based control circuit or the non-computer control source to one or more lower-level driving mechanisms of the autonomous agent; and
implementing a takeover circuit that source s a takeover signal to the dedicated arbiter circuit based on detecting one or more non-computer-based control signals having non-nominal control values from the non-computer control source,
wherein in response to the takeover signal, the dedicated arbiter circuit dynamically switches from passing the computer-based control signals from the computer-based control circuit to passing non-computer-based control signals from the non-computer control source for controlling the one or more lower-level driving mechanisms of the autonomous agent.

19. The method according to claim 18, wherein
in a first, autonomous operating mode of the autonomous agent:
(i) the computer-based control circuit fully controls the driving operations of the autonomous agent without human intervention,
(ii) the dedicated arbiter selectively passes only the computer-based control signals from the computer-based control circuit, and
(iii) the non-computer-based control signals from the non-computer control source include control values for each of the lower-level driving mechanisms that are nominal control values.

20. The method according to claim 19, wherein
in a second, manual operating mode of the autonomous agent:
(i) the non-computer control source controls the driving operations of the autonomous agent,
(ii) the dedicated arbiter selectively passes only the non-computer-based control signals from the non-computer control source, and
(iii) the non-computer control signals from the non-computing control source include control values for each of the lower-level driving mechanisms of the autonomous agent that include non-nominal control values.
